(19) United States
(12) Patent Application Publication
(10) Pub. No.: US 2025/0239078 A1
(43) Pub. Date: Jul. 24, 2025

(54) INSPECTION METHOD AND INSPECTION SYSTEM

(71) Applicant: ASPEED Technology Inc., Hsinchu City (TW)

(72) Inventors: Chen-Wei Chou, Hsinchu City (TW); Jyun-Kai Syong, Hsinchu City (TW)

(73) Assignee: ASPEED Technology Inc., Hsinchu City (TW)

(21) Appl. No.: 18/595,446

(22) Filed: Mar. 5, 2024

(30) Foreign Application Priority Data
Jan. 19, 2024 (TW) 113102165

(51) Int. Cl. G06V 20/52; G06T 7/73; G06V 20/40; H04N 5/77; H04N 7/18

(52) U.S. Cl. CPC G06V 20/52; G06T 7/73; G06V 20/46; H04N 5/77; H04N 7/181; G06T 2207/10016; G06T 2207/20084

(57) ABSTRACT

An inspection method and an inspection system are provided. The inspection method includes: obtaining relative position information between multiple imaging apparatuses; determining an inspection route that satisfies a target event based on the target event and the relative position information, wherein multiple imaging apparatuses included in the inspection route are configured as multiple inspection apparatuses; and controlling a real-time video signal of each inspection apparatus to be presented to a display apparatus based on the inspection route.

### CROSS-REFERENCE TO RELATED APPLICATION

This application claims the priority benefit of Taiwan application Ser. No. 113102165, filed on Jan. 19, 2024. The entirety of the above-mentioned patent application is hereby incorporated by reference herein and made a part of this specification.

### BACKGROUND

### Technical Field

The disclosure relates to a monitoring method and system, and in particular relates to an inspection method and an inspection system based on multiple imaging apparatuses.

### Description of Related Art

Traditional monitoring systems that adopt multiple cameras display the images captured by these cameras separately. Therefore, only fixed angles and fixed positions may be viewed, and the images from multiple cameras cannot be connected in series. In addition, due to the large number of cameras, there are too many images displayed, making it difficult for users to find the target object in the various images. When switching between different cameras, users cannot obtain an immersive experience due to the difference in viewing angles between the cameras.

In addition, the disadvantage of the monitoring system adopting 360-degree cameras is that the degree of freedom is too high, and the user must manually turn to find the target. Even if multiple 360-degree cameras are adopted, image must be viewed by choosing an individual camera. When it is desired to watch a specific target, the traditional monitoring system cannot find the specific target in a short time.

### SUMMARY

The disclosure provides an inspection method and an inspection system that may condense and view real-time video signals that satisfy target events.

An inspection method of the disclosure is adapted for execution using electronic apparatuses. The inspection method includes the following operation. Relative position information between multiple imaging apparatuses are obtained. An inspection route is determined based on a target event and the relative position information, wherein the inspection route satisfies the target event, and multiple imaging apparatuses passed through in the inspection route are set as multiple inspection apparatuses. A real-time video signal of each of the inspection apparatuses are controlled to be presented to a display apparatus based on the inspection route.

In an embodiment of the disclosure, the inspection method further includes the following operation. The relative position information is established between the imaging apparatuses, including the following operation. A plan view corresponding to a space where the imaging apparatuses are disposed is provided. A plurality of plane positions corresponding to the plan view of actual positions where the imaging apparatuses are disposed in the space are marked based on user operation. The relative position information between the imaging apparatuses is calculated based on the plane positions.

In an embodiment of the disclosure, the inspection method further includes the following operation. The relative position information is established between the imaging apparatuses, including the following operation. Multiple images corresponding to the imaging apparatuses are respectively obtained from the imaging apparatuses. The relative position information between the imaging apparatuses is calculated by finding corresponding feature points in each two images.

In an embodiment of the disclosure, the target event includes an event configured to indicate that a specified object is captured. Determining the inspection route includes the following operation. Whether the imaging apparatuses captured the specified object is determined by executing an artificial intelligence (AI) model to execute an object detection algorithm on the real-time video signal received by each of the imaging apparatuses. In response to multiple target apparatuses among the imaging apparatuses capturing the specified object, the inspection apparatuses are determined based on the relative position information and the target apparatuses that captured the specified object. A number of inspection apparatuses included in the inspection route is greater than or equal to a number of target apparatuses.

In an embodiment of the disclosure, after determining whether the imaging apparatuses captured the specified object, the method further includes the following operation. In response to only a first imaging apparatus among the imaging apparatuses capturing the specified object, the inspection route is determined based on the relative position information and the first imaging apparatus that captured the specified object. The inspection route includes at least the first imaging apparatus and a second imaging apparatus corresponding to a preset position.

In an embodiment of the disclosure, after determining whether the imaging apparatus captures a specified object, the method further includes the following operation. In response to the specified object being a device, real-time information of the device is obtained and the real-time information is recorded after detecting the presence of the device in the real-time video signal by executing the object detection algorithm through the artificial intelligence model. Controlling the real-time video signals of each of the inspection apparatuses to be presented to the display apparatus further includes the following operation. In response to the presence of the specified object in the real-time video signal, corresponding real-time information is simultaneously presented in the display apparatus when the real-time video signal is presented to the display apparatus.

In an embodiment of the disclosure, after determining whether the imaging apparatus captures a specified object, the method further includes the following operation. In response to the specified object being a human body, whether the human body is in a dangerous state is determined through the artificial intelligence model after the object detection algorithm executed by the artificial intelligence model detects the presence of the human body in the real-time video signal, and warning information is recorded when it is determined that the human body is in the dangerous state. Controlling the real-time video signals of each of the inspection apparatuses to be presented to the display apparatus further includes the following operation. In response to the presence of the specified object in the real-time video signal and the specified object having the warning information, the warning information is simultaneously presented in the display apparatus when the real-time video signal is presented to the display apparatus.

In an embodiment of the disclosure, after determining whether the imaging apparatus captures a specified object, the method further includes the following operation. In response to the specified object being a human body, a selection frame is generated for selecting the human body through the artificial intelligence model after the object detection algorithm executed by the artificial intelligence model detects a presence of the human body in the real-time video signal. Controlling the real-time video signals of each of the inspection apparatuses to be presented to the display apparatus further includes the following operation. In response to the presence of the specified object in the real-time video signal, the selection frame is simultaneously presented in the display apparatus to select the human body when the real-time video signal is presented to the display apparatus.

In an embodiment of the disclosure, controlling the real-time video signals of each of the inspection apparatuses to be presented to the display apparatus based on the inspection route includes the following operation. A display screen of the display apparatus is switched from the real-time video signal of the first inspection apparatus among the inspection apparatuses to the real-time video signal of the second inspection apparatus among the inspection apparatuses that captured the specified object, which includes the following operation. The first inspection apparatus is controlled to turn to a first direction facing the second inspection apparatus to take images, and the second inspection apparatus is controlled to turn to the first direction. The real-time video signal of the first inspection apparatus facing the first direction is presented to the display screen. A zoom-in operation is executed on the real-time video signal of the first inspection apparatus in the display screen. The second inspection apparatus is controlled to turn from the first direction to a second direction facing the specified object to take images after executing the zoom-in operation. The display screen is synchronously switched to the real-time video signal of the second inspection apparatus during turning process of the second inspection apparatus.

In an embodiment of the disclosure, the target event includes an event configured to indicate inspection of at least one work area. Determining the inspection route includes the following operation. At least one target apparatus corresponding to the at least one work area in the imaging apparatus is selected. The inspection apparatus is determined based on the relative position information and the at least one target apparatus.

In an embodiment of the disclosure, the inspection method further includes the following operation. The inspection apparatuses included in the inspection route are determined based on the target event and at least one other target event. An inspection order of the inspection apparatuses is determined by referring to an event order of the target event and the at least one other target event and basing on the relative position information.

In an embodiment of the disclosure, determining an inspection route includes the following operation. The inspection order of the inspection apparatuses is determined based on the relative position information and a priority order of the imaging apparatuses.

In an embodiment of the disclosure, the process of sequentially displaying the video signals of each of the inspection apparatuses to the display apparatus based on the inspection order further includes the following operation. In response to detecting that a new event satisfies the target event, multiple of the imaging apparatuses are reselected as multiple new inspection apparatuses. A new inspection route of the new inspection apparatuses is re-determined based on the relative position information and an imaging apparatus corresponding to video signal currently displayed by the display apparatus being an inspection starting point. The real-time video signal of each of the new inspection apparatuses are controlled to be presented to the display apparatus based on the new inspection route.

In an embodiment of the disclosure, the inspection method further includes the following operation. An inspection result interface is provided to the display apparatus. The inspection result interface includes a video block, a plan view block, an inspection screenshot block, and an information block. The video block is configured to play real-time video signals in real time. The plan view block is configured to display a plan view corresponding to the space where the imaging apparatus is located, and the plan view includes multiple position information corresponding to the plan view corresponding to the actual position where the imaging apparatus is disposed in a space and a trajectory based on the inspection order. The inspection screenshot block is configured to display a screenshot corresponding to the target event. The information block is configured to display the real-time information corresponding to the target event.

In one embodiment of the disclosure, in the process of controlling the real-time video signals of each of the inspection apparatuses to be presented to the display apparatus based on the inspection route, the following operation is performed. In response to receiving a position selected in the real-time video signal presented on the display apparatus, real-time information corresponding to a specified object or a work area included in the position is simultaneously presented on the display apparatus.

The inspection system of the disclosure includes multiple imaging apparatuses, a display apparatus, and a processor coupled to the imaging apparatuses and the display apparatus. The processor is configured to perform the following operation. Relative position information between the imaging apparatuses are obtained. An inspection route is determined based on the target event and the relative position information, wherein the inspection route satisfies a target event, and multiple imaging apparatuses passing through the inspection route are set as multiple inspection apparatuses. A real-time video signal of each of the inspection apparatuses are controlled to be presented to a display apparatus based on the inspection route.

Based on the above, the disclosure provides an inspection method and an inspection system that may select an apparatus that satisfies the target event from multiple imaging apparatuses and generate an inspection route accordingly. The content obtained by the imaging apparatuses are then displayed based on the inspection route. Accordingly, the real-time video signal that satisfies the target event may be condensed and viewed.

### BRIEF DESCRIPTION OF THE DRAWINGS

FIG. 1 is a schematic diagram of an inspection system according to an embodiment of the disclosure.

FIG. 2 is a schematic diagram of the architecture of an inspection system according to an embodiment of the disclosure.

FIG. 3 is a flowchart of an inspection method according to an embodiment of the disclosure.

FIG. 4 is a schematic diagram of a plan view according to an embodiment of the disclosure.

FIG. 5A to FIG. 5C are schematic diagrams of setting the inspection order according to an embodiment of the disclosure.

FIG. 6 is a schematic diagram of setting an inspection route according to an embodiment of the disclosure.

FIG. 7 is a schematic diagram of an inspection movement manner according to an embodiment of the disclosure.

FIG. 8 is a schematic diagram of an inspection movement manner according to an embodiment of the disclosure.

FIG. 9 is a schematic diagram of a display screen according to an embodiment of the disclosure.

FIG. 10 is a schematic diagram of a display screen according to an embodiment of the disclosure.

FIG. 11 is a schematic diagram of an inspection result interface according to an embodiment of the disclosure.

FIG. 12 is a schematic diagram of a display screen according to an embodiment of the disclosure.

FIG. 13 is a schematic diagram of a display screen according to an embodiment of the disclosure.

FIG. 14 is a schematic diagram of an inspection route according to an embodiment of the disclosure.

FIG. 15 is a schematic diagram of an inspection route according to an embodiment of the disclosure.

### DETAILED DESCRIPTION OF DISCLOSED EMBODIMENTS

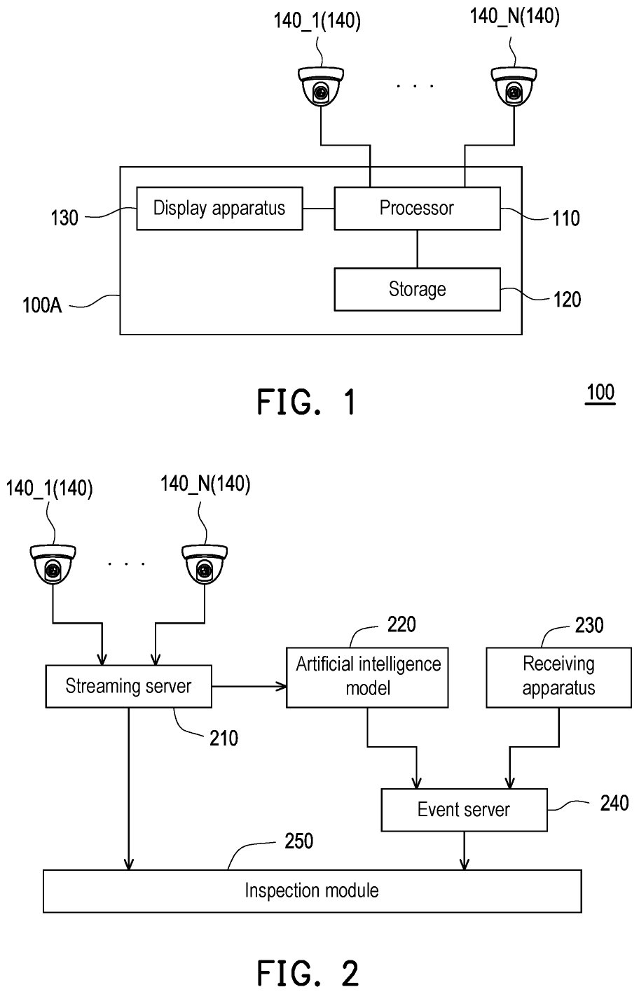

FIG. 1 is a schematic diagram of an inspection system according to an embodiment of the disclosure. Referring to FIG. 1, the inspection system 100 includes a processor 110, a storage 120, a display apparatus 130, and N (N is an integer greater than or equal to 2) imaging apparatuses 140-1 to 140-N(collectively referred to as imaging apparatuses 140). The processor 110 is coupled to the storage 120, the display apparatus 130 and the imaging apparatuses 140-1 to 140-N.

In this embodiment, the processor 110, the storage 120, and the display apparatus 130 may be integrated into the same electronic apparatus 100A. The electronic apparatus 100A is, for example, an apparatus with a computing function such as a smart phone, a tablet, a laptop, a personal computer, a vehicle navigation apparatus, etc. The imaging apparatuses 140-1 to 140-N are connected to the electronic apparatus 100A through wired or wireless communication, so that data may be transmitted between the imaging apparatuses 140-1 to 140-N and the processor 110.

In another embodiment, the processor 110 and the storage 120 may also be integrated into the same electronic apparatus with a computing function such as a smart phone, a tablet, a laptop, a personal computer, a vehicle navigation apparatus, etc. The display apparatus 130 and the imaging apparatuses 140-1 to 140-N are connected to the electronic apparatuses through wired or wireless communication.

The processor 110 is, for example, a central processing unit (CPU), a graphic processing unit (GPU), a physical processing unit (PPU), a programmable microprocessor, an embedded control chip, digital signal processor (DSP), an application specific integrated circuit (ASIC), or other similar apparatuses.

The storage 120 is, for example, any type of fixed or removable random access memory (RAM), read-only memory (ROM), flash memory, a hard drive or other similar devices or a combination of these aparatuses. The storage 120 further includes one or more program code segments. After the above program code segments are installed, the processor 110 executes the inspection method described below.

The display apparatus 130 is implemented by, for example, a display adopting a liquid crystal display (LCD), a plasma display, an organic light-emitting diode (OLED) display, a projection system, etc.

The imaging apparatuses 140-1 to 140-N are video cameras, photographic cameras, etc. using charge coupled device (CCD) lenses or complementary metal oxide semiconductor transistors (CMOS) lenses. For example, the imaging apparatuses 140-1 to 140-N are omnidirectional cameras. A panoramic camera (also known as a 360-degree camera) is a camera whose imaging perspective may cover the entire sphere or at least cover an annular field of view on the horizontal plane. Its types include full-celestial sphere panoramic cameras and semi-celestial sphere panoramic cameras. In addition, the imaging apparatuses 140-1 to 140-N may also be wide-angle cameras. In actual applications, multiple imaging apparatuses 140-1 to 140-N are deployed in a space, and then a monitoring network is established based on the relationship between the imaging apparatuses 140-1 to 140-N.

FIG. 2 is a schematic diagram of the architecture of an inspection system according to an embodiment of the disclosure. Referring to FIG. 2, the inspection system 100 further includes a streaming server 210, an artificial intelligence (AI) model 220, a receiving apparatus 230, an event server 240, and an inspection module 250. Here, the streaming server 210 is an independent server different from the electronic apparatus 100A, and is connected with the electronic apparatus 100A through wired or wireless communication. The streaming server 210 stores the real-time video signals of the imaging apparatuses 140-1 to 140-N, and transmits the real-time video signals to the inspection module 250.

The artificial intelligence model 220 is an application program formed of one or more program code segments disposed in the storage 120 of the electronic apparatus 100A, and is executed by the processor 110 to determine whether the imaging apparatuses 140 capture the specified object by executing an object detection algorithm on the real-time video signals received by each imaging apparatus 140 through the artificial intelligence model 220. In addition, the artificial intelligence model 220 may also be disposed in another electronic apparatus different from the electronic apparatus 100A, and the other electronic apparatus establishes a connection with the electronic apparatus 100A through wired or wireless communication.

The inspection module 250 is an application program formed of one or more program code segments stored in the storage 120 of the electronic apparatus 100A, and is executed by the processor 110 to implement the inspection method described below.

The receiving apparatus 230 is configured to receive real-time information from a device and transmit the real-time information to the event server 240 for storage. The receiving apparatus 230 may be a sensor or a programmable logic controller (PLC) disposed in each device to monitor the operating status of the device in real time.

The event server 240 may be a database system disposed in the electronic apparatus 100A to store real-time information transmitted by the receiving apparatus 230 and store the recognition results of the artificial intelligence model 220. In addition, the event server 240 may also be an independent server different from the electronic apparatus 100A, and is connected with the electronic apparatus 100A through wired or wireless communication. The event server 240 provides the recognition result of the artificial intelligence model 220 and/or the real-time information obtained by the receiving apparatus 230 to the inspection module 250 according to the requirements of the inspection module 250.

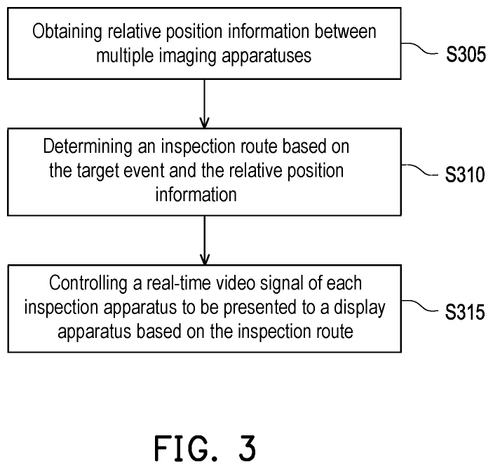

Each step of the inspection method is explained below with reference to the above-mentioned inspection system 100. FIG. 3 is a flowchart of an inspection method according to an embodiment of the disclosure. Referring to FIG. 1 to FIG. 3, in step S305, the processor 110 obtains relative position information between multiple imaging apparatuses 140-1 to 140-N.

In one embodiment, the processor 110 obtains a plan view corresponding to the space where the imaging apparatuses 140-1 to 140-N are disposed, and the plan view includes multiple position information corresponding to the plan view corresponding to the actual positions where the imaging apparatuses 140-1 to 140-N is disposed in the space. Specifically, the processor 110 may display the plan view corresponding to the space to the display apparatus 130, and receive user operations through input devices such as keyboard, mouse, and touch panel to mark the positions of the imaging apparatuses 140-1 to 140-N on the plan view. Afterwards, the processor 110 obtains the relative position information between the imaging apparatuses 140-1 to 140-N based on the position information.

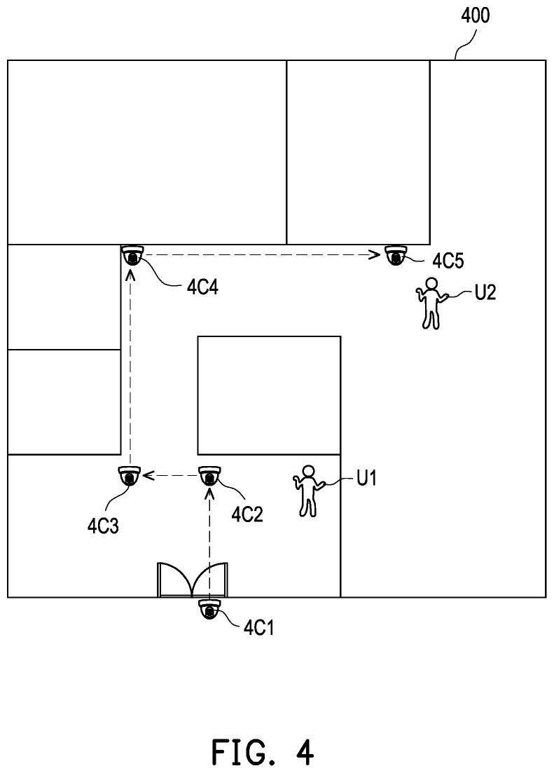

For example, FIG. 4 is a schematic diagram of a plan view according to an embodiment of the disclosure. In FIG. 4, five imaging apparatuses 4C1 to 4C5 are used for description. The plan view 400 may be a simple plan view, or it may be a spatial design drawing in DXF, DWG and other formats drawn by computer aided design (CAD) software.

Referring to FIG. 4, the user may manually set the actual positions of the imaging apparatuses 4C1 to 4C5 in the space relative to the plane position of the plan view 400. For example, the imaging apparatus 4C1 is disposed at the entrance, and the imaging apparatus 4C2 is disposed at the corner of the entrance. After determining the plane positions of the imaging apparatuses 4C1 to 4C5 in the plan view 400, the processor 110 may calculate the relative position information between the imaging apparatuses 4C1 to 4C5 based on the plane positions of the imaging apparatuses 4C1 to 4C5 in the plan view 400, for example, in which direction the imaging apparatus 4C2 is located relative to the imaging apparatus 4C1.

In addition, the processor 110 may also automatically calculate the relative position information between the imaging apparatuses 4C1 to 4C5 according to the images respectively captured by the imaging apparatuses 4C1 to 4C5. For example, the processor 110 respectively obtains corresponding multiple images from the imaging apparatuses 4C1 to 4C5 (one imaging apparatus captures one image), and calculates the relative position information between the imaging apparatuses 4C1 to 4C5 by searching for corresponding feature points in each two images. For example, assuming that the imaging ranges of the imaging apparatus 4C1 and the imaging apparatus 4C2 cover the same area, the corresponding relationship between the two images may be obtained by finding the same feature value based on the two obtained images, for example, in which direction the imaging apparatus 4C2 is located relative to the imaging apparatus 4C1.

The scale-invariant feature transform (SIFT) method or the optical flow method may be used to find the feature points of the same target object in the two images, and operations such as rotation, translation, zoom-in, and zoom-out may be performed on the two images to match the feature points of the target object in the two images to obtain the relative position information between the imaging apparatus 4C1 and the imaging apparatus 4C2. A perspective projection of each imaging apparatus 140 is performed at 90 degrees from the front, back, left and right, and then the corresponding relationship between these images are found after the perspective projection. For example, the relative position information may be a homography transformation matrix between two imaging apparatuses. Through the homography transformation matrix, the included angle and distance between the imaging apparatus 4C1 and the imaging apparatus 4C2 may be known.

In addition, the above-mentioned two methods may also be combined to obtain relative position information. For example, after using the plan view to obtain relative position information, the corresponding angles of the plan view marking method are adopted to perform perspective projection, and then a comparison is performed.

Next, in step S310, the processor 110 determines the inspection route based on the target event and relative position information. Here, the determined inspection route satisfies the target event, and multiple imaging apparatuses that are passed through in the inspection route are set as multiple inspection apparatuses. That is, the selected inspection apparatuses may satisfy the content of the target event. For example, the target event may be an event configured to indicate that a specified object is captured. For example, the specified object may be a human bodies, an animal, a plant, a home appliance, an electronic instrument, a device, building materials, etc. Alternatively, the target event may also be an event configured to indicate at least one work area (e.g., test area, production area, and packaging area). The processor 110 may further determine the inspection order of the inspection apparatuses based on the relative position information and the priority order of the imaging apparatuses 140-1 to 140-N. In other embodiments, the user may also manually set the inspection order of the inspection apparatus.

Taking the target event as an event indicating that a specified object is captured, the processor 110 determines whether each imaging apparatus 140 captures a specified object by executing an object detection algorithm on the real-time video signal received by each imaging apparatus 140 through executing the artificial intelligence model 220. In response to multiple target apparatuses in the imaging apparatuses 140-1 to 140-N capturing the specified object, multiple inspection apparatuses are determined based on the relative position information and the target apparatus that captured the specified object. Here, the number of multiple inspection apparatuses included in the inspection route is greater than or equal to the number of target apparatuses.

In addition, in response to only one imaging apparatus (the first imaging apparatus) capturing the specified object, at least two inspection apparatuses are determined based on the relative position information and the first imaging apparatus that captured the specified object. That is, the inspection route includes at least a first imaging apparatus and a second imaging apparatus corresponding to the preset position.

The following description is based on the architecture of FIG. 2 and the disposition of the imaging apparatus corresponding to the plan view 400 of FIG. 4, and it is assumed that the specified object is a human body. The processor 110 determines whether the imaging apparatuses 4C1 to 4C5 captured the specified object by executing an object detection algorithm on the real-time video signals of the imaging apparatuses 4C1 to 4C5 by using the artificial intelligence model 220. As shown in FIG. 4, the artificial intelligence model 220 determines that the imaging apparatus 4C2 and the imaging apparatus 4C5 respectively captures the users U1 and U2. Then, the processor 110 further determines the inspection apparatus in the inspection route according to the relative position information, the imaging apparatus 4C2 and the imaging apparatus 4C5. Here, the processor 110 sets the imaging apparatus 4C2 and the imaging apparatus 4C5 as inspection apparatuses. Moreover, since the capturing ranges of the imaging apparatus 4C2 and the imaging apparatus 4C5 do not intersect, therefore, the processor 110 further selects the imaging apparatus 4C3 and the imaging apparatus 4C4 as the inspection apparatuses according to a route setting rule (e.g., along the aisle of the space, along the route of the production line, or the priority order of the imaging apparatuses 4C1 to 4C5) and the relative position information.

In addition, in this embodiment, a preset position is further set as the position where the inspection starts or the position where the inspection ends. For example, the “entrance” of the inspected space is set as the default position. Taking FIG. 4 as an example, the preset position is the doorway, which corresponds to the imaging apparatus 4C1. The processor 110 further sets the imaging apparatus 4C1 corresponding to the preset position as the inspection apparatus. Afterwards, the processor 110 determines the inspection route with the imaging apparatus 4C1, the imaging apparatus 4C2, the imaging apparatus 4C3, the imaging apparatus 4C4, and the imaging apparatus 4C5 in sequence as the inspection order based on the relative position information.

After setting the inspection order of the imaging apparatuses 4C1 to 4C5, during the inspection process, the processor 110 may further control the display screen to turn to the direction where the users U1 and U2 are present. For example, taking FIG. 4 as an example, the display screen of the display apparatus 130 switches from the real-time video signal of the imaging apparatus 4C1 to the real-time video signal of the imaging apparatus 4C2. Then, the display screen turns to the direction of the user U1, and then switches to the real-time video signals of the imaging apparatus 4C3, the imaging apparatus 4C4, and the imaging apparatus 4C5 in sequence. Finally, the display screen turns to the direction of the user U2.

In addition, if only one imaging apparatus (for example, imaging apparatus 4C1) captures the specified object, in order to achieve the inspection effect, the processor 110 may use the imaging apparatus 4C2 that captures the specified object and the imaging apparatus 4C1 corresponding to the preset position (e.g., an entrance corresponding to the space) as the inspection apparatuses, and then determine the inspection route including the imaging apparatus 4C1 and the imaging apparatus 4C2 (as the inspection apparatuses) according to the relative position information. In addition, in response to only one imaging apparatus (first imaging apparatus) capturing the specified object, at least three inspection apparatuses are determined based on the relative position information, the first imaging apparatus that captured the specified object, and the second imaging apparatus and the third imaging apparatus corresponding to the two preset positions (the position where the inspection starts and the position where the inspection ends).

In addition, returning to FIG. 1, taking the target event is an event that indicates the inspection of at least one work area as an example, the processor 110 selects the imaging apparatus corresponding to the specified one or more work areas as the target apparatus according to the distribution positions of the imaging apparatuses 140-1 to 140-N, and determines the inspection apparatus based on the relative position information and the target apparatus. Here, the preset position may be further set as the position where the inspection starts or the position where the inspection ends. The processor 110 determines multiple inspection apparatuses based on the relative position information, the target apparatus, and the imaging apparatus corresponding to the preset position (the position where the inspection starts or the position where the inspection ends).

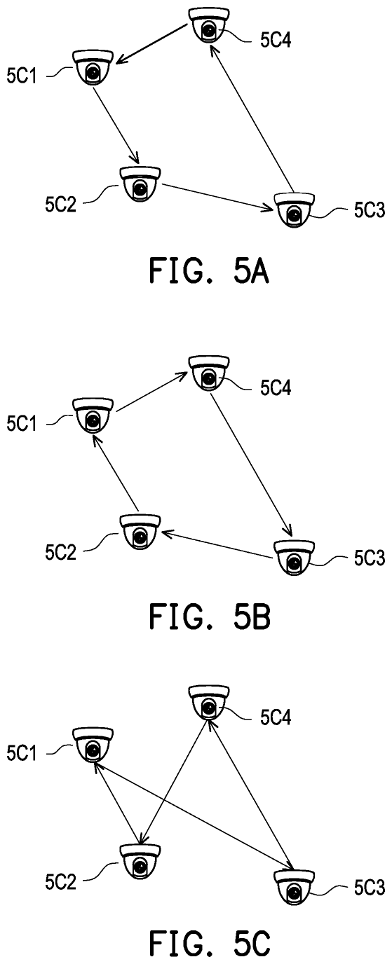

After determining the inspection apparatus, the processor 110 further determines the inspection order. For example, the inspection order may be determined by clockwise movement, counterclockwise movement, minimum rotation angle, shortest path movement, etc. For example, FIG. 5A to FIG. 5C are schematic diagrams of setting the inspection order according to an embodiment of the disclosure. Referring to FIG. 5A to FIG. 5C, in this embodiment, it is assumed that there are four imaging apparatuses 5C1 to 5C4 that satisfy the target event. The inspection order of the imaging apparatuses 5C1 to 5C4 may be counterclockwise movement as shown in FIG. 5A, or clockwise movement as shown in FIG. 5B. In addition, as shown in FIG. 5C, the inspection order of the imaging apparatuses 5C1 to 5C4 may also be set based on each imaging apparatus transitioning to the next one with the rotation of a minimum angle. Alternatively, the inspection order of the imaging apparatuses 5C1 to 5C4 may also be set by the shortest movement path.

In addition, in order to connect two imaging apparatuses that satisfy the target event, the imaging apparatuses that do not satisfy the target event may also be selected as the inspection apparatus. For example, it is assumed that the imaging ranges of two inspection apparatuses (imaging apparatuses that satisfy the target event) do not overlap. Therefore, when the real-time video signal of one inspection apparatus transitions to the real-time video signal of another inspection apparatus, the image will be incoherent. Accordingly, in order to connect the two inspection apparatuses, at least one imaging apparatus may be further selected as the inspection apparatus between the two apparatuses.

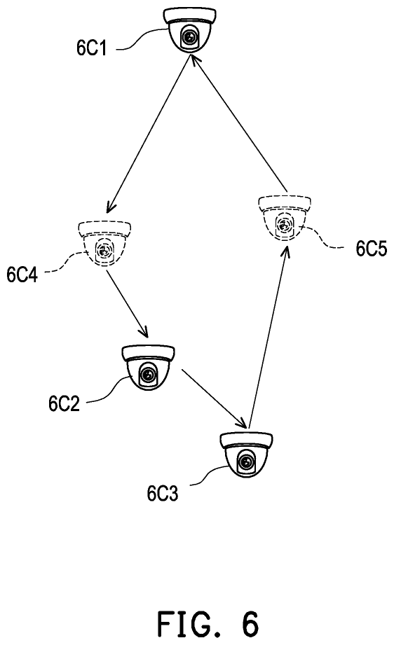

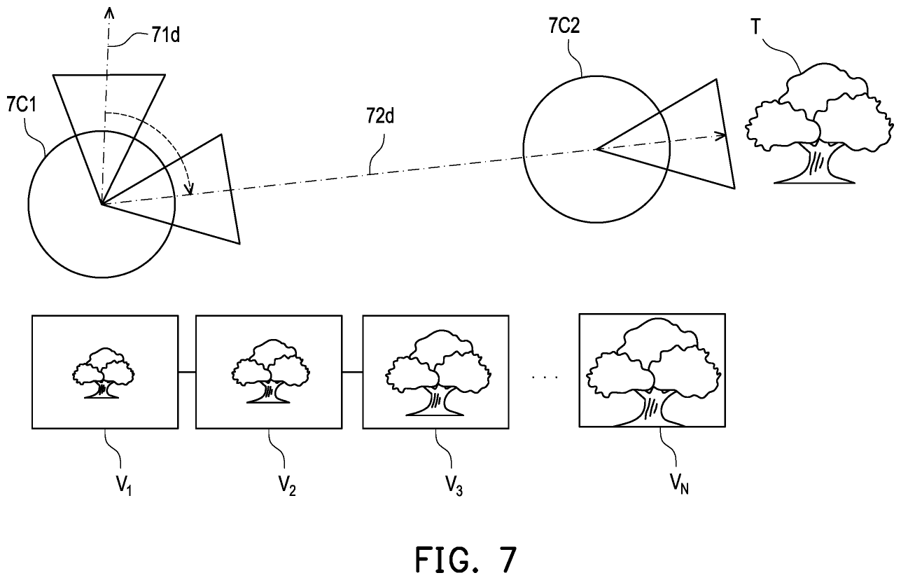

FIG. 6 is a schematic diagram of setting an inspection route according to an embodiment of the disclosure. Referring to FIG. 6, it is assumed that there are three imaging apparatuses 6C1 to 6C3 that satisfy the target event. It is assumed that the imaging ranges of the imaging apparatus 6C1 and the imaging apparatus 6C2 do not overlap, and the imaging ranges of the imaging apparatus 6C1 and the imaging apparatus 6C3 do not overlap. Accordingly, in addition to setting the image capturing apparatuses 6C1 to 6C3 as the inspection apparatuses, the image capturing apparatus 6C4 may also be selected as the inspection apparatus between the image capturing apparatus 6C1 and the image capturing apparatus 6C2, and the imaging apparatus 6C5 is selected as the inspection apparatus between the imaging apparatus 6C1 and the imaging apparatus 6C3.

In addition, when there are multiple target events, the inspection order may also be determined based on the event order of the target events. The processor 110 respectively determines multiple inspection apparatuses included in the inspection route based on multiple target events, and then determines the inspection order of the multiple inspection apparatuses based on the event order of these target events and the relative position information. For example, taking the target event includes a first event of capturing a human body and a second event of capturing a specified device, and the order of the first event takes precedence over the order of the second event as an example, the order of the inspection apparatus that satisfies the first event is set before the inspection apparatus that satisfies the second event.

After determining the inspection route, in step S315, the processor 110 controls the real-time video signals of each inspection apparatus to be presented to the display apparatus 130 based on the inspection route. That is, based on the inspection order, the processor 110 switches the display screen of the display apparatus 130 from the real-time video signal of the first inspection apparatus to the real-time video signal of the second inspection apparatus. Then, the display screen of the display apparatus 130 is switched to the real-time video signal of the third inspection apparatus, and so on. The display screen of the display apparatus 130 is switched to the real-time video signal of the last inspection apparatus.

Transition effects may be added when switching between two real-time video signals so that the display screen may be visually coherent.

FIG. 7 is a schematic diagram of an inspection movement manner according to an embodiment of the disclosure. Referring to FIG. 7, in this embodiment, the imaging apparatus 7C1 performs inspection toward the imaging apparatus 7C2 as an example for description. The description is based on the fact that the object T is present in the direction 72d, but it is not limited thereto. The processor 110 controls the imaging apparatus 7C1 to turn from the direction 71d to the direction 72d facing the imaging apparatus 7C2 to capture images, and controls the imaging apparatus 7C2 to face the direction 72d. Next, the processor 110 presents the real-time video signal V1 obtained by the imaging apparatus 7C1 facing the direction 72d to the display screen, controls the imaging apparatus 7C1 to perform a zoom in operation to sequentially present the real-time video signals V2 to VN on the display screen, and then switches the display screen to the real-time video signal of the imaging apparatus 7C2. Accordingly, the display screen may be visually coherent.

Moreover, in addition to the manner of performing zoom-in operation on the real-time video signal of the imaging apparatus 7C1 to the maximum limit and then transitioning to the real-time video signal of the imaging apparatus 7C2, the inspection manner may also be moving freely within a certain distance (limited range) from the center of the field of view of an imaging apparatus. Taking FIG. 7 as an example, during the process of jumping from the imaging apparatus 7C1 to the imaging apparatus 7C2, the display screen may also move in the direction of the imaging apparatus 7C2 within the limit range of the imaging apparatus 7C1. After moving to the limit, the real-time video signal of the imaging apparatus 7C1 is zoomed in to the limit through the zoom-in operation, and then the display screen transitions to the real-time video signal of the imaging apparatus 7C2. This may make the viewer feel more immersed, as if they are walking in the environment.

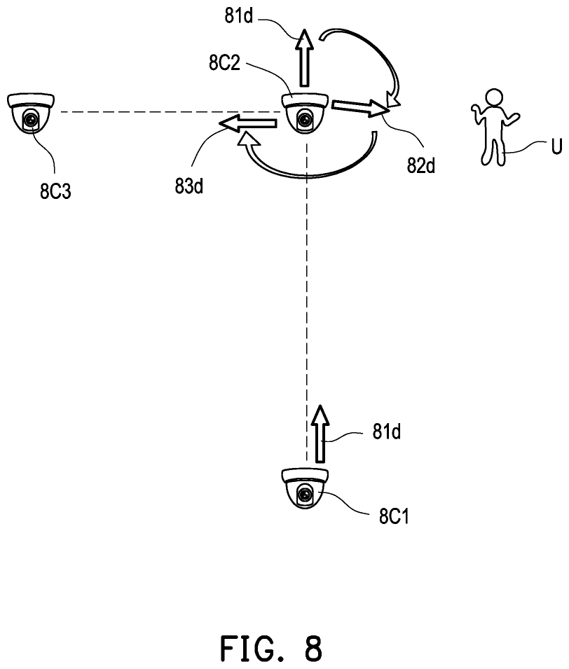

FIG. 8 is a schematic diagram of an inspection movement manner according to an embodiment of the disclosure. Referring to FIG. 8, in this embodiment, the inspection order is the imaging apparatus 8C1, the imaging apparatus 8C2 and the imaging apparatus 8C3, in which a user U is present at the imaging apparatus 8C2 as an example for description. The processor 110 controls the imaging apparatus 8C1 to turn to the direction 81d facing the imaging apparatus 8C2 to capture images, and controls the imaging apparatus 8C2 to turn to the direction 81d. Next, the processor 110 presents the real-time video signal of the imaging apparatus 8C1 facing the direction 81d to the display screen, and performs a zoom-in operation on the real-time video signal of the imaging apparatus 8C1 in the display screen. After executing the zoom-in operation to the maximum limit, the processor 110 controls the imaging apparatus 8C2 to turn from the direction 81d to the direction 82d facing the specified object (i.e., the user U) to capture the image, and synchronously switches the display screen to the real-time video signal of the imaging apparatus 8C2 during the turning process of the imaging apparatus 8C2. Accordingly, the display screen may present a visual effect of turning from the direction 81d to the direction 82d. Then, the processor 110 controls the imaging apparatus 8C2 to turn from the direction 82d to the direction 83d facing the imaging apparatus 8C3 to capture images, and presents the real-time video signal obtained by the imaging apparatus 8C2 to the display screen. Afterwards, the processor 110 presents the real-time video signal of the imaging apparatus 8C2 facing the direction 83d to the display screen, and performs a zoom-in operation on the real-time video signal of the imaging apparatus 8C2 in the display screen. After executing the zoom-in operation to the maximum limit, the display screen is switched to the real-time video signal of the imaging apparatus 8C3.

During the inspection process, the processor 110 may further use the artificial intelligence model 220 to obtain real-time information of the specified object, or may receive real-time information of the device from the receiving apparatus 230 and further present it on the display screen. For example, real-time information may be presented by adopting on-screen display (OSD), warning lights, pop-up notification, Internet of things (IoT), manufacturing execution systems (MEMS), etc.

In response to the specified object being a device, after the artificial intelligence model 220 executes the object detection algorithm and detects the presence of the device in the real-time video signal, the processor 110 obtains real-time information of the device from the receiving apparatus 230 and records the real-time information. Afterwards, when the display screen is controlled to present the real-time video signals of each imaging apparatus, in response to the presence of the specified object (device) in the real-time video signals, when the real-time video signals are presented to the display apparatus 130, corresponding real-time information is simultaneously presented on the display apparatus 130.

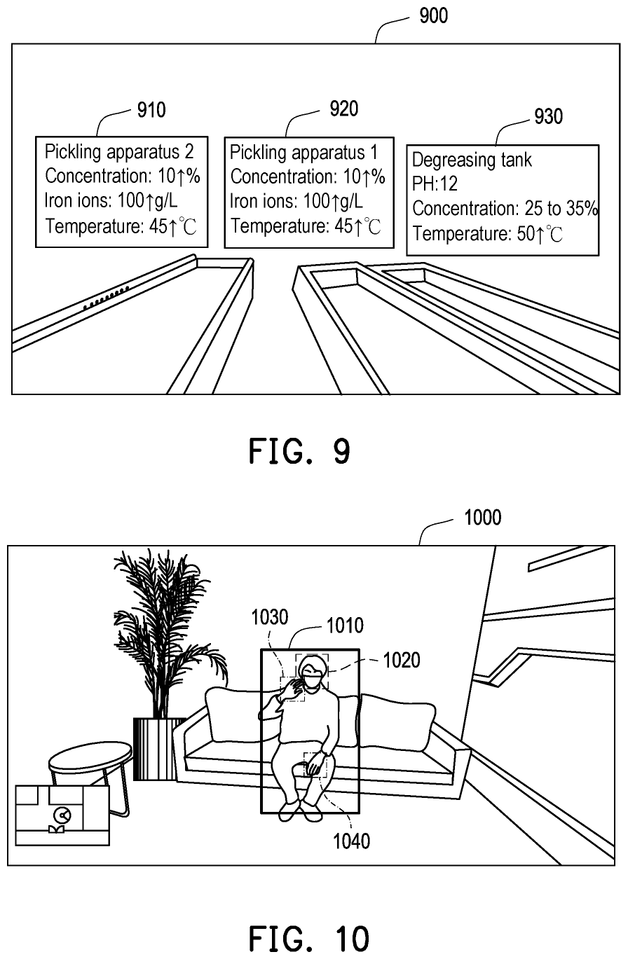

FIG. 9 is a schematic diagram of a display screen according to an embodiment of the disclosure. Referring to FIG. 9, three devices (pickling apparatus one, pickling apparatus two and degreasing tank) are present in the real-time video signal currently presented on the display screen 900. Accordingly, the processor 110 simultaneously presents three text boxes 910 to 930 on the display screen 900 to respectively display real-time information corresponding to the three devices.

In another embodiment, during the execution of step S315, in response to receiving a position selected in the real-time video signal presented in the display apparatus 130, real-time information corresponding to the specified object or work area included in the position is simultaneously presented in the display apparatus 130. That is, the user may select a position in the real-time video signal presented by the display apparatus 130, and the user may decide the information to be presented at this position, or the processor 110 may further identify whether the selected position in the real-time video signal corresponds to a specified object (e.g., home appliance, electronic instrument, device, building materials) or a work area (e.g., a test area, production area, packaging area). When it is determined that the selected position corresponds to the specified object or work area, the processor 110 simultaneously displays real-time information corresponding to the specified object or work area to the display apparatus 130.

In addition, in response to the specified object being a human body, after the artificial intelligence model 220 executes the object detection algorithm and detects the presence of the human body in the real-time video signal, the artificial intelligence model 220 generates a selection frame for selecting the human body. Afterwards, when the display screen is controlled to present the real-time video signals of each imaging apparatus, in response to the presence of the specified object (human body) in the real-time video signals, when the real-time video signals are presented to the display apparatus 130, a selection frame is simultaneously presented on the display apparatus 130 to select the human body. In addition, a selection frame that frames a specific part such as the palm of the hand may also be further generated.

FIG. 10 is a schematic diagram of a display screen according to an embodiment of the disclosure. Referring to FIG. 10, a human body is present in the video signal currently presented on the display screen 1000. Accordingly, the processor 110 simultaneously presents the selection frame 1010 on the display screen 1000 to select the human body, and further presents a selection frame 1020 to select the head of the human body, and presents a selection frame 1030 and a selection frame 1040 to select the palms of the human body.

In addition, in response to the specified object being a human body, after the object detection algorithm is executed by the artificial intelligence model 222 to detect the presence of a human body in the real-time video signal, the artificial intelligence model 222 is used to determine whether the human body is in a dangerous state (e.g., a person is falling, not wearing a helmet, entering a dangerous area, etc.). When it is determined that the human body is in a dangerous state, warning information is recorded. Afterwards, when the display screen is controlled to present the real-time video signals of each imaging apparatus, in response to the presence of the specified object in the real-time video signal and the specified object having the warning information, when the real-time video signals are presented to the display apparatus 130, warning information is simultaneously presented on the display apparatus 130. In addition, it may also be set so that when a specified object is present in the real-time video signal, when the real-time video signal is presented to the display apparatus 130, real-time information related to the specified object is simultaneously presented in the display apparatus 130.

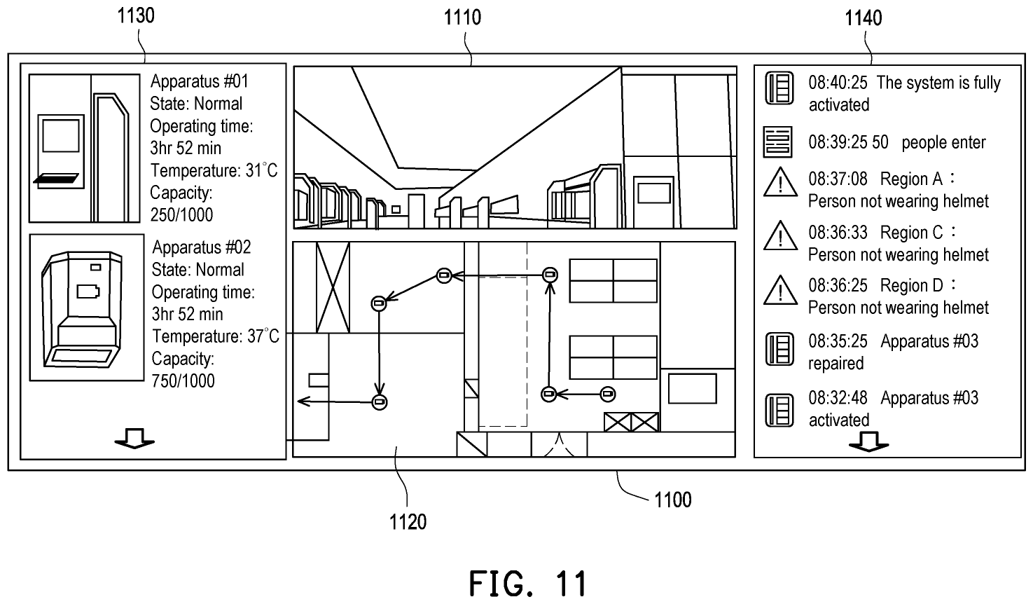

In the process of determining the inspection route and performing inspection among multiple video signals through the display screen, in response to detecting that a new event satisfies the currently specified target event, the processor 110 further reselects multiple apparatuses among the imaging apparatuses 140 as new inspection apparatuses. For example, during the inspection process, if it is detected through the artificial intelligence model 220 that another user enters the imaging range of one of the imaging apparatuses, the processor 110 re-executes steps S310 and S315. The imaging apparatus corresponding to the video signal currently displayed by the display apparatus 130 is taken as the inspection starting point, and the new inspection route of the new inspection apparatus is re-determined based on the relative position information. The real-time video signals of each new inspection apparatus are controlled to be presented to the display apparatus 130 based on the new inspection route. That is to say, the inspection system 100 may change the inspection route at any time based on the current status. The processor 110 may be further configured to provide an inspection result interface to the display apparatus 130. FIG. 11 is a schematic diagram of an inspection result interface according to an embodiment of the disclosure. Referring to FIG. 11, the inspection result interface 1100 includes a video block 1110, a plan view block 1120, an inspection screenshot block 1130, and an information block 1140. The video block 110 is configured to play real-time video signals in real time. The plan view block 1120 is configured to display a plan view corresponding to the space where the imaging apparatus is located, and the plan view includes multiple position information corresponding to the plan view corresponding to the actual position where each of the imaging apparatuses is disposed in a space and a trajectory based on the inspection order. The inspection screenshot block 1130 is configured to display a screenshot corresponding to the target event, for example, to display a screenshot of each device. The information block 1140 is configured to display the real-time information corresponding to the target event. For example, the embodiment of FIG. 11 specifies two target events, that is, an event in which a human body is captured and an event in which a device is captured. Therefore, the real-time information of each device is displayed synchronously in the information block 1140, such as “Apparatus #03 repaired”, “Apparatus #06 activated”, and when it is determined that the human body is in a dangerous state, the corresponding warning information is displayed, such as “Region A: Person not wearing helmet”.

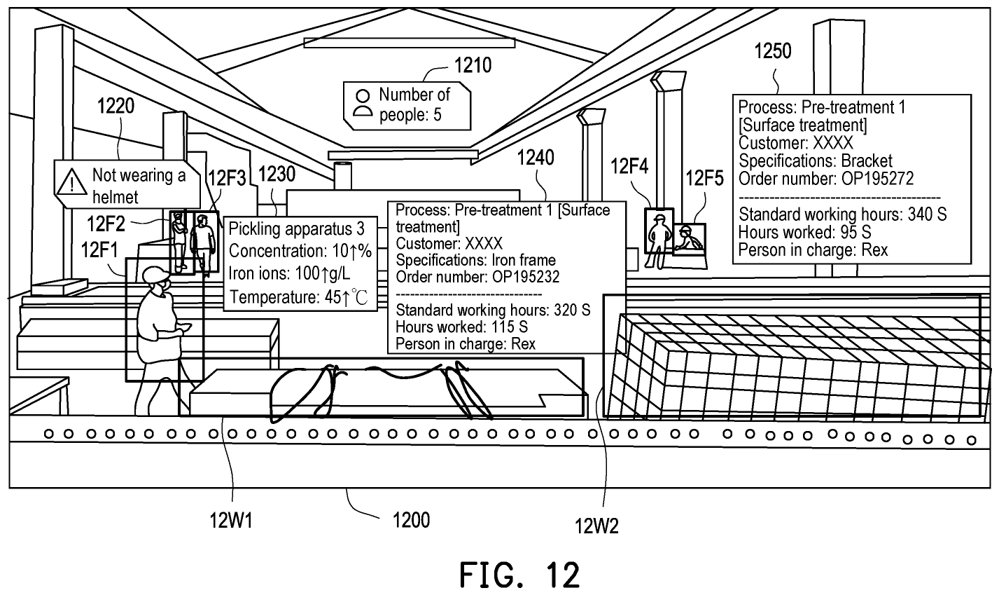

In another embodiment, real-time information and/or warning information may also be directly superimposed on the real-time video signal presented on the display screen. FIG. 12 is a schematic diagram of a display screen according to an embodiment of the disclosure. Referring to FIG. 12, the display screen 1200 simultaneously presents selection frames 12F1 to 12F5, selection frames 12W1 to 12W2, and text boxes 1210 to 1250. The selection frames 12F1 to 12F5 are configured to select the human body in the real-time video signal. The selection frames 12W1 to 12W2 are configured to select specified building materials in the real-time video signal. The text box 1210 is configured to present the number of people detected in the currently displayed real-time video signal. The text box 1220 corresponds to the selection frame 12F2 and is configured to present the warning signal of the human body selected by the selection frame 12F2, such as “not wearing a helmet”. The text box 1230 is configured to present real-time information of the detected device (e.g., the pickling tank), such as temperature, concentration and other operating conditions. The text box 1240 and the text box 1250 respectively correspond to the selection frames 12W1 to 12W2, and are configured to present real-time information of the building materials selected by the selection frames 12W1 to 12W2, such as the operation content and production capacity status of the building materials.

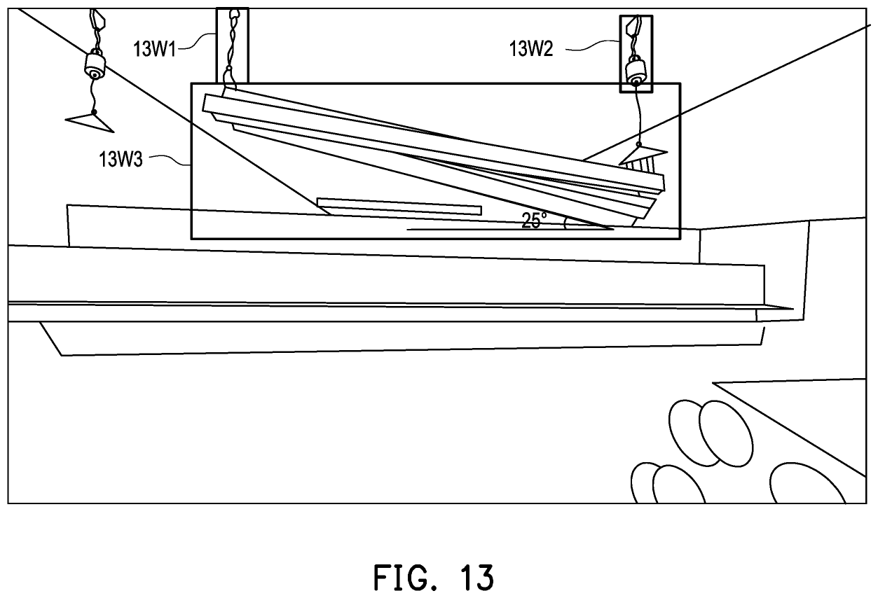

FIG. 13 is a schematic diagram of a display screen according to an embodiment of the disclosure. Referring to FIG. 13, the selection frames 13W1 to 13W3 are simultaneously presented in the display screen 1300. The selection frames 13W1 and 13W2 select iron hooks, and the selection frame 13W3 selects building materials. The processor 110 may further detect the included angle between the lifted building material and the horizontal plane, synchronously present the angle information on the display screen 1300, and dynamically change the presented angle information as the actual operating angle changes.

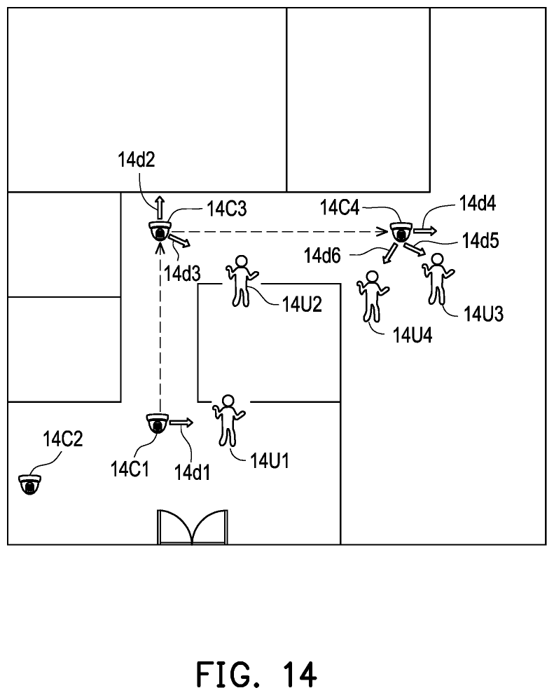

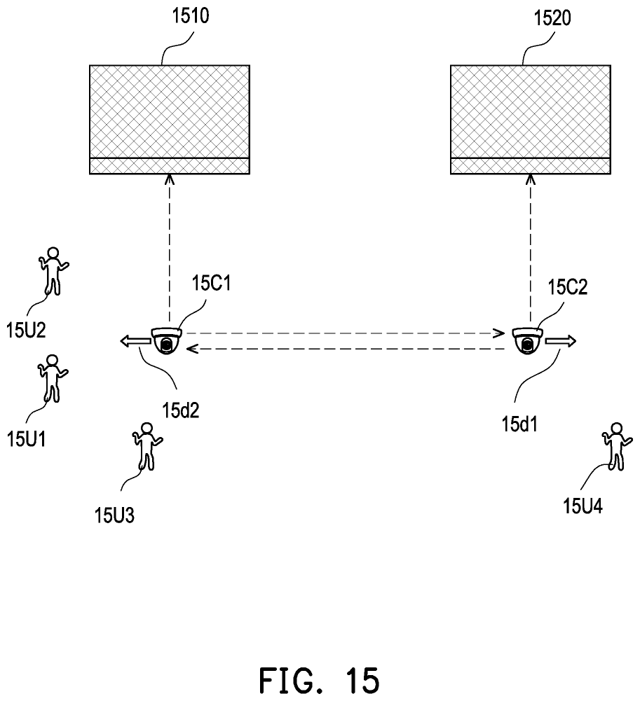

FIG. 14 is a schematic diagram of an inspection route according to an embodiment of the disclosure. Referring to FIG. 14, in this embodiment, the imaging apparatuses 14C1 to 14C4 are disposed in the space, and the users 14U1 to 14U4 are present in this space. Since the imaging apparatus 14C2 does not capture a person, the imaging apparatus 14C2 is not set as an inspection apparatus. After the processor 110 determines that the inspection apparatuses are the imaging apparatuses 14C1, 14C3, and 14C4 and the inspection order, the processor 110 first controls the display screen of the display apparatus 130 to present the real-time video signal of the imaging apparatus 14C1, then controls the display screen to turn to the direction 14dl of the user 14U1, and then controls the display screen to display the real-time video signal that the imaging apparatus 14C1 turns to the direction 14d2 facing the imaging apparatus 14C3.

Afterwards, the processor 110 controls the display screen of the display apparatus 130 to switch to the real-time video signal (facing the direction 14d2) of the imaging apparatus 14C3, then controls the display screen to turn to the direction 14d3 of the user 14U2, and then turns to the direction 14d4 facing the imaging apparatus 14C4. Next, the processor 110 controls the display screen of the display apparatus 130 to switch to the real-time video signal (facing the direction 14d4) of the imaging apparatus 14C4, then controls the display screen to turn to the direction 14d5 of the user 14U3, and then to the direction 14d6 of the user 14U4.

FIG. 15 is a schematic diagram of an inspection route according to an embodiment of the disclosure. Referring to FIG. 15, in this embodiment, devices 1510 and 1520 and imaging apparatuses 15C1 and 15C2 are disposed in the space, and the users 14U1 to 14U4 are present in this space. After determining that the inspection order of the imaging apparatuses 15C1 and 15C2 is from the imaging apparatus 15C1 to the imaging apparatus 15C2, the processor 110 executes the following steps A to D in sequence. In step A, the processor 110 controls the imaging apparatus 15C1 to capture images facing the device 1510 to present the obtained real-time video signal on the display screen of the display apparatus 130. Afterwards, in step B, the processor 110 controls the imaging apparatus 15C1 to capture images in the direction 15dl facing the imaging apparatus 15C2, and controls the imaging apparatus 15C2 to also capture images facing the direction 15dl, so that the display screen switches from the real-time video signal of the imaging apparatus 15C1 to the real-time video signal (facing the direction 15dl) of the imaging apparatus 15C2.

Next, in step C, the processor 110 controls the imaging apparatus 15C2 to capture images facing the device 1520 to present the obtained real-time video signal on the display screen of the display apparatus 130. Finally, in step D, the processor 110 controls the imaging apparatus 15C2 to capture images in the direction 15d2 facing the imaging apparatus 15C1, and controls the imaging apparatus 15C1 to also capture images facing the direction 15d2, so that the display screen switches from the real-time video signal of the imaging apparatus 15C2 to the real-time video signal (facing the direction 15d2) of the imaging apparatus 15C1. Then, steps A to D are repeated. Since the target event of this embodiment is to capture the specified devices 1510 and 1520, the imaging apparatuses 15C1 and 15C2 do not specifically turn to the direction of the user. In the embodiment shown in FIG. 15, for example, when the imaging apparatus 15C1 turns from the direction 15d2 to the device 1510, the user 15U2 will be captured and displayed in the display screen.

In addition, for users who do not appear in the inspection route, a picture-in-picture (PIP) may also be used to present the users who do not appear in the inspection route. For example, taking FIG. 15 as an example, after the display screen in step D is switched to the real-time video signal (facing the direction 15d2) of the imaging apparatus 15C1, a picture-in-picture may be used to display the users 15U1, 15U2, and 15U3.

To sum up, the disclosure provides an inspection method and an inspection system that may select an apparatus that satisfies the target event from multiple imaging apparatuses and generate an inspection route accordingly. The content obtained by the imaging apparatuses are then condensed and displayed based on the inspection route. Accordingly, images that match the target event may be quickly obtained from multiple real-time video signals and displayed on the display apparatus.

What is claimed is:

1. An inspection method, adapted for execution using an electronic apparatus, the inspection method comprising:
obtaining relative position information between a plurality of imaging apparatuses;
determining an inspection route based on a target event and the relative position information, wherein the inspection route satisfies the target event, and setting multiple imaging apparatuses passed through in the inspection route as a plurality of inspection apparatuses; and
controlling a real-time video signal of each of the inspection apparatuses to be presented to a display apparatus based on the inspection route.

2. The inspection method according to claim 1, further comprising: establishing the relative position information between the imaging apparatuses, comprising:
providing a plan view corresponding to a space where the imaging apparatuses are disposed;
marking a plurality of plane positions corresponding to the plan view of actual positions where the imaging apparatuses are disposed in the space in the plan view based on user operation; and
calculating the relative position information between the imaging apparatuses based on the plane positions.

3. The inspection method according to claim 1, further comprising: establishing the relative position information between the imaging apparatuses, comprising:
respectively obtaining a plurality of images corresponding to the imaging apparatuses from the imaging apparatuses; and
calculating the relative position information between the imaging apparatuses by finding corresponding feature points in each two images.

4. The inspection method according to claim 1, wherein the target event comprises an event configured to indicate that a specified object is captured,
determining the inspection route comprises:
determining whether the imaging apparatuses captured the specified object by executing an artificial intelligence model to execute an object detection algorithm on the real-time video signal received by each of the imaging apparatuses; and
in response to a plurality of target apparatuses among the imaging apparatuses capturing the specified object, determining the inspection apparatuses based on the relative position information and the target apparatuses that captured the specified object, wherein a number of the inspection apparatuses comprised in the inspection route is greater than or equal to a number of the target apparatuses.

5. The inspection method according to claim 4, wherein after determining whether the imaging apparatuses captured the specified object, further comprises:
in response to only a first imaging apparatus among the imaging apparatuses capturing the specified object, determining the inspection route based on the relative position information and the first imaging apparatus that captured the specified object, wherein the inspection route comprises at least the first imaging apparatus and a second imaging apparatus corresponding to a preset position.

6. The inspection method according to claim 4, wherein after determining whether the imaging apparatuses captured the specified object, further comprises:
in response to the specified object being a device, obtaining real-time information of the device and recording the real-time information after detecting a presence of the device in the real-time video signal by executing the object detection algorithm through the artificial intelligence model;
wherein controlling the real-time video signal of each of the inspection apparatuses to be presented to the display apparatus further comprises:
in response to the presence of the specified object in the real-time video signal, simultaneously presenting the corresponding real-time information in the display apparatus when the real-time video signal is presented to the display apparatus.

7. The inspection method according to claim 4, wherein after determining whether the imaging apparatuses captured the specified object, further comprises:
in response to the specified object being a human body, determining whether the human body is in a dangerous state through the artificial intelligence model after the object detection algorithm executed by the artificial intelligence model detects a presence of the human body in the real-time video signal, and recording warning information when it is determined that the human body is in the dangerous state;
wherein controlling the real-time video signal of each of the inspection apparatuses to be presented to the display apparatus further comprises:
in response to the presence of the specified object in the real-time video signal and the specified object having the warning information, simultaneously presenting the warning information in the display apparatus when the real-time video signal is presented to the display apparatus.

8. The inspection method according to claim 4, wherein after determining whether the imaging apparatuses captured the specified object, further comprises:
in response to the specified object being a human body, generating a selection frame for selecting the human body through the artificial intelligence model after the object detection algorithm executed by the artificial intelligence model detects a presence of the human body in the real-time video signal;
wherein controlling the real-time video signal of each of the inspection apparatuses to be presented to the display apparatus further comprises:
in response to the presence of the specified object in the real-time video signal, simultaneously presenting the selection frame in the display apparatus to select the human body when the real-time video signal is presented to the display apparatus.

9. The inspection method according to claim 4, wherein controlling the real-time video signal of each of the inspection apparatuses to be presented to the display apparatus based on the inspection route comprises:
switching a display screen of the display apparatus from a real-time video signal of a first inspection apparatus among the inspection apparatuses to a real-time video signal of a second inspection apparatus among the inspection apparatuses that captured the specified object, comprising:
controlling the first inspection apparatus to turn to a first direction facing the second inspection apparatus to take images, and controlling the second inspection apparatus to turn to the first direction;
presenting the real-time video signal of the first inspection apparatus facing the first direction to the display screen;
executing a zoom-in operation on the real-time video signal of the first inspection apparatus in the display screen; and
controlling the second inspection apparatus to turn from the first direction to a second direction facing the specified object to take images after executing the zoom-in operation, and synchronously switching the display screen to the real-time video signal of the second inspection apparatus during turning process of the second inspection apparatus.

10. The inspection method according to claim 1, wherein the target event comprises an event configured to indicate inspection of at least one work area,
determining the inspection route comprises:
selecting at least one target apparatus corresponding to the at least one work area in the imaging apparatus; and
determining the inspection apparatus based on the relative position information and the at least one target apparatus.

11. The inspection method according to claim 1, further comprising:
determining the inspection apparatuses comprised in the inspection route based on the target event and at least one other target event; and
determining an inspection order of the inspection apparatuses by referring to an event order of the target event and the at least one other target event and basing on the relative position information.

12. The inspection method according to claim 1, wherein determining the inspection route comprises:
determining an inspection order of the inspection apparatuses based on the relative position information and a priority order of the imaging apparatuses.

13. The inspection method according to claim 1, wherein a process of sequentially displaying the video signal of each of the inspection apparatuses to the display apparatus based on the inspection route further comprises:
in response to detecting that a new event satisfies the target event, reselecting multiple of the imaging apparatuses as a plurality of new inspection apparatuses;
re-determining a new inspection route of the new inspection apparatuses based on the relative position information and an imaging apparatus corresponding to video signal currently displayed by the display apparatus being an inspection starting point; and
controlling the real-time video signal of each of the new inspection apparatuses to be presented to the display apparatus based on the new inspection route.

14. The inspection method according to claim 1, further comprising:
providing an inspection result interface to the display apparatus, wherein the inspection result interface comprises a video block, a plan view block, an inspection screenshot block, and an information block,
the video block is configured to play real-time video signals in real time,
the plan view block is configured to display a plan view corresponding to a space where the imaging apparatus is located, and the plan view comprises a plurality of position information corresponding to the plan view corresponding to actual positions where the imaging apparatuses are disposed in the space and a trajectory based on an inspection order,
the inspection screenshot block is configured to display a screenshot corresponding to the target event,
the information block is configured to display real-time information corresponding to the target event.

15. The inspection method according to claim 1, wherein a process of controlling the real-time video signal of each of the inspection apparatuses to be presented to the display apparatus based on the inspection route further comprises:
in response to receiving a position selected in the real-time video signal presented on the display apparatus, simultaneously presenting real-time information corresponding to a specified object or a work area comprised in the position on the display apparatus.

16. An inspection system, comprising:
a plurality of imaging apparatuses;
a display apparatus; and
a processor, coupled to the imaging apparatuses and the display apparatus, wherein the processor is configured to:
obtaining relative position information between the imaging apparatuses;
determining an inspection route based on a target event and the relative position information, wherein the inspection route satisfies the target event, and setting multiple imaging apparatuses passed through in the inspection route as a plurality of inspection apparatuses; and
controlling a real-time video signal of each of the inspection apparatuses to be presented to a display apparatus based on the inspection route.
